(19) United States
(12) Patent Application Publication
(10) Pub. No.: US 2006/0063048 A1
(43) Pub. Date: Mar. 23, 2006

(54) Optimal temperature tracking for necessary and accurate thermal control of a fuel cell system

(76) Inventor: Jason R. Kolodziej, West Henrietta, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/948,402

(22) Filed: Sep. 23, 2004

(51) Int. Cl. H01M 8/04

(52) U.S. Cl. 429/24; 429/13; 429/26

(57) ABSTRACT

A temperature control scheme for a fuel cell stack thermal sub-system in a fuel cell system. The thermal sub-system includes a coolant loop directing the cooling fluid through the stack, a pump for pumping the cooling fluid through the coolant loop, a radiator for cooling the cooling fluid outside of the fuel cell stack and a bypass valve for selectively directing the cooling fluid in the coolant loop through the radiator or around the radiator. The control scheme generates an optimal model of the thermal sub-system using non-linear equations, and controls the speed of the pump and a position of the bypass valve in combination.

### BACKGROUND OF THE INVENTION

1. Field of the Invention

This invention relates generally to a fuel cell system and, more particularly, to a control scheme for controlling the temperature and flow rate of a cooling fluid flowing through a fuel cell stack in a fuel cell system.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. A PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Many fuel cells are typically combined in a fuel cell stack to generate the desired power. For example, a typical fuel cell stack for an automobile may have two hundred stacked fuel cells. The fuel cell stack receives a cathode input gas, typically a flow of air forced through the stack by a compressor. Not all of the oxygen in the air is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the MEA. Cathode gas flow channels are provided on the cathode side of the bipolar plates that allow the cathode gas to flow to the MEA. The bipolar plates are made of a conductive material, such as stainless steel, so that they conduct the electricity generated by the fuel cells out of the stack. The bipolar plates also include flow channels through which a cooling fluid flows.

It is necessary that a fuel cell operate at an optimum relative humidity and temperature to provide efficient stack operation and durability. The temperature provides the relative humidity within the fuel cells in the stack for a particular stack pressure. Excessive stack temperature above the optimum temperature may damage fuel cell components, reducing the lifetime of the fuel cells. Also, stack temperatures below the optimum temperature reduces the stack performance.

Fuel cell systems employ thermal sub-systems that control the temperature within the fuel cell stack. Particularly, a cooling fluid is pumped through the cooling channels in the bipolar plates in the stack. The known thermal sub-systems in the fuel cell system attempt to control the temperature of the cooling fluid being input into the fuel cell stack and the temperature difference between the cooling fluid into the stack and the cooling fluid out of the stack, where the cooling fluid flow rate controls the temperature difference.

FIG. 1 is a schematic plan view of a fuel cell system 10 including a thermal sub-system for providing cooling fluid to a fuel cell stack 12. The cooling fluid that flows through the stack 12 flows through a coolant loop 14 outside of the stack 12 where it either provides heat to the stack 12 during start-up or removes heat from the stack 12 during fuel cell operation to maintain the stack 12 at a desirable operating temperature, such as 60° C.-80° C. An input temperature sensor 16 measures the temperature of the cooling fluid in the loop 14 as it enters the stack 12 and an output temperature sensor 18 measures the temperature of the cooling fluid in the loop 14 as it exits the stack 12.

A pump 20 pumps the cooling fluid through the coolant loop 14, and a radiator 22 cools the cooling fluid in the loop 14 outside of the stack 12. A fan 24 forces ambient air through the radiator 22 to cool the cooling fluid as it travels through the radiator 22. A bypass valve 26 is positioned within the coolant loop 14, and selectively distributes the cooling fluid to the radiator 22 or around the radiator 22 depending on the temperature of the cooling fluid. For example, if the cooling fluid is at a low temperature at system start-up or low stack power output, the bypass valve 26 will be controlled to direct the cooling fluid around the radiator 22 so that heat is not removed from the cooling fluid and the desired operating temperature of the stack 12 can be maintained. As the power output of the stack 12 increases, more of the cooling fluid will be routed to the radiator 22 to reduce the cooling fluid temperature. A controller 28 controls the position of the bypass valve 28, the speed of the pump 20 and the speed of the fan 24 depending on the temperature signals from the temperature sensors 16 and 18, the power output of the stack 12 and other factors.

The known temperature control schemes for fuel cell thermal sub-systems independently controlled the speed of the pump 20 and the position of the bypass valve 26. Particularly, the speed of pump 20 is used to control the difference between the input temperature of the cooling fluid provided to the stack 12 and the output temperature of the cooling fluid out of the stack 12 at some nominal value. The bypass valve 26 is used to control the temperature of the cooling fluid sent to the stack 12. Because the speed of the pump 20 and the position of the bypass valve 26 are independently controlled, fluctuations in the temperature of the stack 12 may significantly deviate from the optimum temperature, and thus the performance and durability of the system 10 may be reduced.

### SUMMARY OF THE INVENTION

In accordance with the teachings of the present invention, a temperature control scheme for a fuel cell stack thermal sub-system in a fuel system is disclosed that provides an optimum stack temperature. The thermal sub-system includes a coolant loop directing a cooling fluid through the stack, a pump for pumping the cooling fluid through the coolant loop, a radiator for cooling the cooling fluid outside of the fuel cell stack and a bypass valve for selectively directing the cooling fluid in the coolant loop through the radiator or around the radiator. In one embodiment, the pump and the bypass valve are positioned downstream from an output of the radiator.

A controller controls the position of the bypass valve and the speed of the pump in combination with each other by solving differential equations based on a system model. The system model is used to determine a first matrix that is representative of the temperature of the cooling fluid coming out of the stack and the temperature of the cooling fluid coming out of the radiator. The system model is also used to determine a second time-varying matrix based on the desired temperature set point of the fuel cell stack. The system model is also used to determine a third time-varying matrix based on the output power of the fuel cell stack. The first, second and third matrices are used to generate a control matrix for controlling the speed of the pump and the position of the bypass valve.

Additional advantages and features of the present invention will become apparent from the following description and appended claims, taken in conjunction with the accompanying drawings.

### BRIEF DESCRIPTION OF THE DRAWINGS

FIG. 1 is a schematic plan view of a cooling system for a fuel cell stack in a fuel cell system of the type known in the art;

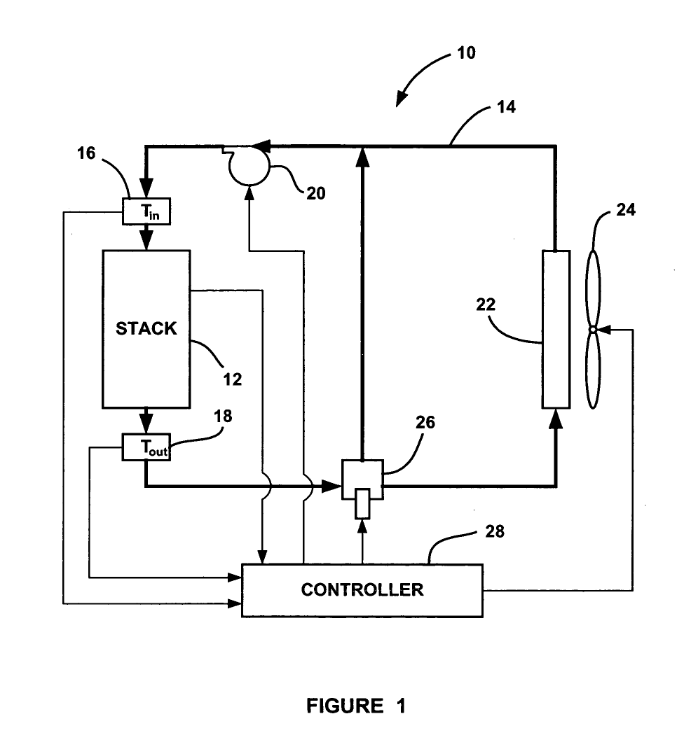

FIG. 2 is a schematic plan view of a cooling system for a fuel cell stack in a fuel cell system, according to an embodiment of the present invention; and

FIG. 3 is a block diagram of a controller for the system shown in FIG. 2.

### DETAILED DESCRIPTION OF THE EMBODIMENTS

The following discussion of the embodiments of the invention directed to a control scheme for a thermal sub-system in a fuel cell system is merely exemplary in nature, and is in no way intended to limit the inventions or its application or uses. For example, the discussion herein describes a control scheme for a fuel cell system on a vehicle. However, the control scheme may have application for fuel cells for other uses.

According to the invention, an optimal controller for a thermal sub-system of the fuel cell system 10 is described and includes developing a model of the system 10. By performing an energy balance of the components in the system 10 and applying well-known thermodynamics, the non-linear equations shown in equations (1)-(3) below represent the dynamics of the system 10.

$$\begin{matrix}\frac{ⅆ}{ⅆ t} [ {( ρ ( Vol ) {C}_{p} )}_{cool} {T}_{stk , out} ] = {\dot{m}}_{stk} {C}_{p , c} ( 1 - X ) ( {T}_{rad , out} - {T}_{stk , out} ) + {\dot{Q}}_{gen} & ( 1 ) \\ \frac{ⅆ}{ⅆ t} [ {( ρ ( Vol ) {C}_{p} )}_{cool} {T}_{rad , out} ] = {\dot{m}}_{stk} {C}_{p , c} ( 1 - X ) ( {T}_{stk , out} - {T}_{rad , out} ) - \frac{Q}{ITD} ( {T}_{rad , in} - {T}_{air , in} ) & ( 2 ) \\ \frac{ⅆ}{ⅆ t} [ {( ρ ( Vol ) {C}_{p} )}_{air} {T}_{air , out} ] = {\dot{m}}_{air} {C}_{p , a} ( {T}_{air , in} - {T}_{air , out} ) + \frac{Q}{ITD} ( {T}_{rad , in} - {T}_{air , in} ) & ( 3 )\end{matrix}$$

Where, p is the density of the coolant and air;

Vol is the volume of the stack 12 and the radiator 22;

Cₚ is the specific heat of the coolant air;

T_{stk,out} is the temperature of the cooling fluid out of the stack 12 and is a state variable;

T_{rad,out} is the temperature of the cooling fluid out of the radiator 22 and is a state variable;

T_{air,out} is the temperature of the air out of the radiator 22 and is a state variable;

T_{air,in} is the temperature of the air into the radiator 22 and is an input variable;

T_{rad,in} is the temperature of the cooling fluid into the radiator 22 and is a state variable;

\dot{m}ₛₜₖ is the coolant flow through the stack 12 and is an input reflective of the pump commanded flow;

\dot{m}ₐᵢᵣ is the airflow through the radiator 22;

X is the position of the bypass valve 26 and varies between 0 and 1;

Q/ITD (heat rejection/inlet temperature difference) is a family of curves representing the performance of the radiator 22; and

\dot{Q}_{gen} represents the energy generated by the fuel cell stack 12.

Stack thermal mass is not considered to simplify the equations (1)-(3), thereby increasing the controllability analysis. Inflated volume numbers can be used to account for an increased thermal lag while eliminating a dynamic equation. No thermal losses are assumed through the piping of the system 10. Either the plumbing is well insulated or the distances are short.

The equations (1)-(3) are based on the physics of the system 10. The control system design becomes important when deciding what variable to control. It is universally accepted that a temperature of the cooling fluid flowing into or out of the fuel cell stack 12, as well as the temperature across the stack 12, is of paramount important when accurate relative humidity control is required. This gives the following equations (4) and (5) from the above model.
y₁=T_{stk,in}=(X)T_{stk,out}+(1−X)T_{rad,out} (4)
y₂=ΔT=(1−X)(T_{stk,out}−T_{rad,out}) (5)

A problem with the equations (4) and (5) is the presence of the position of the bypass valve 26. This implies that one of the inputs directly affects both of the desired outputs. While this is not necessarily bad, it does add two more non-linear equations to the control problem causing further complexity when attempting to apply linearization and/or linear control techniques. In addition, a non-minimum phase system can result, which leads to stability problems, slow responses and difficulty in tracking control.

Known control techniques typically employ coupled PID loops. One loop controls the change in temperature of the cooling fluid between the fluid input and output of the stack 12 with the coolant flow \dot{m}ₛₜₖ, while the other loop controls T_{stk,in} with the position of the bypass valve 26. From the coupled non-linear equations (4) and (5), it is clear that two decoupled loops will interact with each other causing less than optimal, and sometimes unstable, behavior.

As will be discussed below, by optimizing the combined control of the pump 20 and the bypass valve 26, the system 10 can anticipate temperature changes to the fuel cell stack 12, and can increase the speed of the pump 20 or redirect more flow to the radiator 22 using the bypass valve 26 before the temperature actually increases.

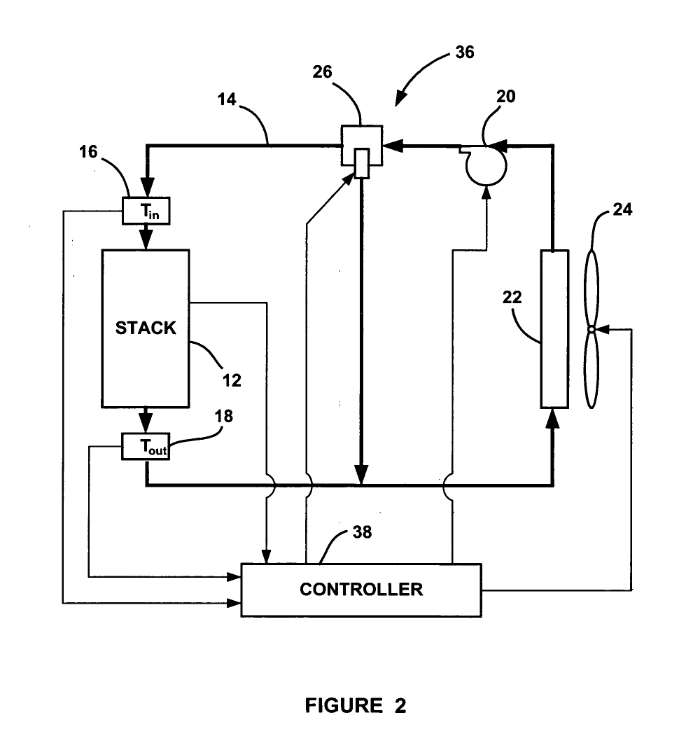

FIG. 2 is a schematic block diagram of a fuel system 36, according to an embodiment of the present invention. The fuel cell system 36 is similar to the system 10 discussed above, where like elements are identified by the same reference numeral. The fuel cell system 36 includes a controller 38 that optimizes the performance of the thermal sub-system by using a system model to develop an optimal control law combines the control of the pump 20 and the bypass valve 26, as will be discussed in detail below. According to the invention, the control scheme will anticipate changes in the temperature of the cooling fluid and provide a desirable control before the temperature change occurs.

According to one embodiment of the invention, the pump 20 and the bypass valve 26 are positioned at a different location in the cooling loop 14 than in the system 10, as shown. This position for the pump 20 and the bypass valve 26 is by way of a non-limiting example in that the control scheme described below has application for any suitable position for the pump 20 and the bypass valve 26, including the positions shown in the system 10.

There are only very subtle differences between the fuel cell systems 10 and 36, which is essential because there is no increase in system cost. The main problem with the system 10 is that the bypass valve 26 set the blending of the two coolant loops before going into the stack inlet. The new location of the bypass valve 26 in the system 36 either allows cooling fluid from the radiator 22 or does not allow cooling fluid from the radiator 22, which means that the cooling fluid temperature out of the radiator 22 is the cooling fluid temperature into the stack 12. The location of the bypass valve 26 essentially sets the location of the pump 20.

Based on the model developed above, the resulting non-linear dynamic equations (6)-(8) for the system 36 are:

$$\begin{matrix}\frac{ⅆ}{ⅆ t} [ {( ρ ( Vol ) {C}_{p} )}_{cool} {T}_{stk , out} ] = {\dot{m}}_{rad} {C}_{p , c} ( X ) ( {T}_{rad , out} - {T}_{stk , out} ) + {Q}_{gen} & ( 6 ) \\ \frac{ⅆ}{ⅆ t} [ {( ρ ( Vol ) {C}_{p} )}_{cool} {T}_{rad , out} ] = {\dot{m}}_{rad} {C}_{p , c} ( X ) ( {T}_{stk , out} - {T}_{rad , out} ) - \frac{Q}{ITD} ( {T}_{rad , in} - {T}_{air , in} ) & ( 7 ) \\ \frac{ⅆ}{ⅆ t} [ {( ρ ( Vol ) {C}_{p} )}_{air} {T}_{air , out} ] = {\dot{m}}_{air} {C}_{p , a} ( {T}_{air , in} - {T}_{air , out} ) + \frac{Q}{ITD} ( {T}_{rad , in} - {T}_{air , in} ) & ( 8 )\end{matrix}$$

Note that the thermal dynamic equations (6)-(8) for the system 36 are nearly the same as the equations (1)-(3) for the system 10. They are again non-linear, but this is unavoidable, and it is in the desired output equations where the greatest impact is seen.
y₁=T_{stk,in}=T_{rad,out} (9)
y₂=ΔT=(T_{stk,out}−T_{stk,in})=(T_{stk,out}−T_{rad,out} ) (10)

For the equations (9) and (10), the desired outputs result in linear combinations of state variables, thus eliminating the bypass valve input directly affecting the output. Further simplification provides:
y₁=T_{stk,in}=T_{rad,out} (11)
y₂=T_{stk,out} (12)
The T_{stk,out} set-point is the desired T_{stk,in}+ΔT_{des}.

By using the two dynamic equations (11) and (12), two linearization techniques can be applied, particularly feedback linearization and a Taylor series linearization. Since Taylor series approximation can be unreliable when the operating point deviates from the linearization point, it is advantageous to apply feedback linearization first, although either method would result in a linear model of the system 36.

Taking the set of state equations (6)-(8) and defining two new inputs, v and w, gives:

$$\begin{matrix}v = {\dot{m}}_{rad} {C}_{p , c} ( X ) ( {T}_{rad , out} - {T}_{stk , out} ) & ( 13 ) \\ w = \frac{Q}{ITD} ( {T}_{rad , in} - {T}_{air , in} ) & ( 14 ) \\ \frac{Q}{ITD} = f ( {\dot{m}}_{rad} , - {T}_{air , in} , \text{geometry} ) & ( 15 )\end{matrix}$$

Which yields:

$$[ \begin{matrix}\frac{ⅆ}{ⅆ t} [ {( ρ ( Vol ) {C}_{p} )}_{cool} {T}_{stk , out} ] \\ \frac{ⅆ}{ⅆ t} [ {( ρ ( Vol ) {C}_{p} )}_{cool} {T}_{rad , out} ]\end{matrix} ] = [ \begin{matrix}0 & 0 \\ 0 & 0\end{matrix} ] [ \begin{matrix}{T}_{stk , out} \\ {T}_{rad , out}\end{matrix} ] + [ \begin{matrix}1 & 0 \\ - 1 & - 1\end{matrix} ] [ \begin{matrix}v \\ w\end{matrix} ] + [ \begin{matrix}1 \\ 0\end{matrix} ] {\dot{Q}}_{gen} \qquad ( 16 )$$

The equation (8) is dropped because it does not affect the desired outputs. It can still be included, but it will only give the air temperature outside of the radiator 22. The resulting output equation is:

$$[ \begin{matrix}{y}_{1} \\ {y}_{2}\end{matrix} ] = [ \begin{matrix}0 & 1 \\ 1 & 0\end{matrix} ] [ \begin{matrix}{T}_{stk , out} \\ {T}_{rad , out}\end{matrix} ] + [ \begin{matrix}0 & 0 \\ 0 & 0\end{matrix} ] [ \begin{matrix}v \\ w\end{matrix} ] + [ \begin{matrix}1 \\ 0\end{matrix} ] {\dot{Q}}_{gen} \qquad ( 17 )$$

This completes the linearization portion of the control strategy. From this point it is possible to apply any number of linear control schemes including, but not limited to, optimal control, robust control and pole placement.

The controller 38 provides an optimal control based on a tracking linear quadratic regulator (LQR) with a known disturbance. LQR has been well documented in linear control literature where the goal is to return (regulate) the state variable to zero, but subject to a system disturbance. In the system 36, a state output of zero is not desirable. It is rather desirable to have the thermal sub-system outputs T_{stk,out} and T_{stk,in} track a given temperature set-point based on a calculation from a desired relative humidity. In addition, the tracking controller has a known disturbance \dot{Q}_{gen} that is also included in the control law.

Replacing the equations (16) and (17) with variables representing matrices results in:
\dot{x}=Ax+Bu+Ed (18)
y=Cx (19)
In the equations (18) and (19), A is a state matrix that defines the physical properties of the system 36, B is an input matrix that defines the input effects on the system 36, C is an output matrix that defines what variables are being measured, and E is an input matrix that is a disturbance influence on the system 36 and defines the effect of stack power.

$$\begin{matrix}\underline{x} = [ \begin{matrix}{T}_{stk , out} \\ {T}_{rad , out}\end{matrix} ] & u = [ \begin{matrix}v \\ w\end{matrix} ] & d = {\dot{Q}}_{gen} & y = [ \begin{matrix}{T}_{stk , in} \\ {T}_{stk , out}\end{matrix} ] \\ A = [ \begin{matrix}0 & 0 \\ 0 & 0\end{matrix} ] & B = [ \begin{matrix}1 & 0 \\ - 1 & - 1\end{matrix} ] & E = [ \begin{matrix}1 \\ 0\end{matrix} ] & C = [ \begin{matrix}0 & 1 \\ 1 & 0\end{matrix} ]\end{matrix}$$

The following series of equations are not required to implement the control law. They are only the development of the control law. As with all optimal control laws, a cost function subject to constraints is defined as:

$$\begin{matrix}min J = \frac{1}{2} {e}_{F}^{T} {Fe}_{F} + \frac{1}{2} {\int }_{{t}_{o}}^{t} ( {e}^{T} Qe + {u}^{t} Rud τ ) & ( 20 ) \\ s . t . \underline{\dot{x}} = A \underline{x} + B \underline{u} + Ed & ( 21 ) \\ y = C \underline{x} & ( 22 )\end{matrix}$$

Where the error e is defined as:
e=z−y (23)
Where z is the desired temperature set-point and y is the output of the thermal sub-system.

The goal of the optimization in the equations (20)-(22) is to make the cost function as small as possible. Since the terminal condition is not important in this case, F=0, leaving just the integral as the cost function. This means that the designer must choose a positive semi-definite Q matrix and a positive definite R matrix that sufficiently balances the integral so that the optimization penalizes the error e between the set-point and the output Q and the controller action u through the R matrix. The constraint in this optimization problem is the dynamic state equations themselves. This essentially forces the determined control law to be applicable to the system under consideration.

Forming the Hamiltonian and inserting the co-state variable A gives:

$$H = \frac{1}{2} ( {e}^{T} Qe + {u}^{T} Ru ) + {λ}^{T} ( Ax + Bu + Ed ) \qquad ( 24 )$$

Substituting the equation (23) into the equation (24) gives:

$$H = \frac{1}{2} ( {( z - Cx )}^{T} Q ( z - Cx ) + {u}^{T} Ru ) + {λ}^{T} ( Ax + Bu + Ed ) \qquad ( 25 )$$

Solving for the state equation (25) gives:

$$\dot{x} = \frac{\partial H}{\partial λ} = Ax + Bu + {Ed}^{} \qquad ( 26 )$$

The co-state equation is given as:

$$\dot{λ} = \frac{\partial H}{\partial x} = {C}^{T} Q ( z - Cx ) - {A}^{T} λ \qquad ( 27 )$$

Solving for the controller output u gives:

$$\begin{matrix}\frac{\partial H}{\partial u} = 0 = \frac{1}{2} ( 2 Ru ) + {B}^{T} λ & ( 28 ) \\ u = - {R}^{- 1} {B}^{T} λ & ( 29 )\end{matrix}$$

Substituting the equations (28) and (29) into the equations (26) and (27) gives:
\dot{x}=Ax−BR⁻¹B^{T}λ+Ed (30)
\dot{λ}=C^{T}Qz−C^{T}QCx−A^{T}λ (31)

Putting the equations (30) and (31) in a state-space form gives:

$$[ \begin{matrix}\dot{x} \\ \dot{λ}\end{matrix} ] = [ \begin{matrix}A & - {BR}^{- 1} {B}^{T} \\ - {C}^{T} QC & - {A}^{T}\end{matrix} ] [ \begin{matrix}x \\ λ\end{matrix} ] + [ \begin{matrix}E & 0 \\ O & {C}^{T} Q\end{matrix} ] [ \begin{matrix}d \\ z\end{matrix} ] \qquad ( 32 )$$

Solving for the boundary conditions gives:

$$[ \begin{matrix}x ( T ) \\ λ ( T )\end{matrix} ] = [ \begin{matrix}{Φ}_{11} & {Φ}_{12} \\ {Φ}_{21} & {Φ}_{22}\end{matrix} ] [ \begin{matrix}x ( t ) \\ λ ( t )\end{matrix} ] + {\int }_{{t}_{o}}^{t} [ \begin{matrix}{Φ}_{11} ( t , τ ) & {Φ}_{12} ( t , τ ) \\ {Φ}_{21} ( t , τ ) & {Φ}_{22} ( t , τ )\end{matrix} ] [ \begin{matrix}Ez \\ {C}^{T} Qd\end{matrix} ] ⅆ τ \qquad ( 33 )$$

Expanding the equation (33) defines four dummy variables:

$$\begin{matrix}x ( T ) = {Φ}_{11} x ( t ) + {Φ}_{12} λ ( t ) + \int {Φ}_{11} ( t , τ ) Ez ⅆ τ + \int {Φ}_{12} ( t , τ ) {C}^{T} Q ⅆ ⅆ τ = {Φ}_{11} x ( t ) + {Φ}_{12} λ ( t ) + {f}_{1} + {h}_{1} & ( 34 ) \\ {f}_{1} = \int {Φ}_{11} ( t , τ ) Ez ⅆ τ & ( 35 ) \\ {h}_{1} = \int {Φ}_{12} ( t , τ ) {C}^{T} Q ⅆ ⅆ τ & ( 36 ) \\ λ ( T ) = {Φ}_{21} x ( t ) + {Φ}_{22} λ ( t ) + \int {Φ}_{21} ( t , τ ) Ez ⅆ τ + \int {Φ}_{22} ( t , τ ) {C}^{T} Q ⅆ ⅆ τ = {Φ}_{21} x ( t ) + {Φ}_{22} λ ( t ) + {f}_{2} + {h}_{2} & ( 37 ) \\ {f}_{2} = \int {Φ}_{21} ( t , τ ) Ez ⅆ τ & ( 38 ) \\ {h}_{2} = \int {Φ}_{22} ( t , τ ) {C}^{T} Q ⅆ ⅆ τ & ( 39 )\end{matrix}$$

Further applying boundary conditions (F=0) gives:

$$\begin{matrix}λ ( T ) = \frac{\partial J}{\partial x ( T )} = \frac{1}{2} {e}_{F}^{T} {Fe}_{F} = \frac{1}{2} {( z - Cx )}^{T} F ( z - Cx ) = \frac{1}{2} [ z ( - {C}^{T} ) F ( z - Cx ) ] & ( 40 ) \\ λ ( T ) = - {C}^{T} Fz ( T ) + {C}^{T} FCx ( T ) & ( 41 )\end{matrix}$$

Substitution the equations (40) and (41) into the equations (37)-(39) gives:
−C^{T}Fz(T)+C^{T}FCx(T)=Φ₂₁x(t)+Φ₂₂λ(t) +f₂+h₂ (42)

Substituting the equations (34)-(36) into the equation (42) and simplifying for λ (t) gives:

$$\begin{matrix}- {C}^{T} Fz ( T ) + {C}^{T} FC [ {Φ}_{11} x ( t ) + {Φ}_{12} λ ( t ) + {f}_{1} + {h}_{1} ] = {Φ}_{21} x ( t ) + {Φ}_{22} λ ( t ) + {f}_{2} + {h}_{2} & ( 43 ) \\ λ ( t ) = {( {C}^{T} {FCΦ}_{12} - {Φ}_{22} )}^{- 1} [ ( {Φ}_{21} - {C}^{T} {FCΦ}_{11} ) x ( t ) - {C}^{T} Fz ( t ) + {C}^{T} {FCf}_{1} - {f}_{2} + {C}^{T} {FCh}_{1} - {h}_{2} ] & ( 44 )\end{matrix}$$

Defining three new variables K, f(t) and h(t) gives:
λ(t)=Kx(t)+f(t)+h(t) (45)
Where,
K=(C^{T}FCΦ₁₂−Φ₂₂)⁻¹(Φ₂₁−C^{T}FCΦ₁₁) (46)
f(t)=(C^{T}FCΦ₁₂−Φ₂₂)⁻¹(−C^{T}Fz(t)+C^{T}FCf₁−f₂) (47)
h(t)=(C^{T}FCΦ₁₂−Φ₂₂)⁻¹(C^{T}FCh₁−h₂) (48)

Substituting the equation (45) into the equations (28)-(32) gives the optimal control law for set-point tracking subject to a known disturbance input as:
u=−R⁻¹B^{T}(Kx(t)+f(t)+h(t)) (49)

Differentiating the equation (45) gives:
\dot{λ}(t)=\dot{K}x(t)+K\dot{x}(t)+\dot{f}(t)+\dot{h}(t) (50)

Substituting the equation (44) into the equation (32) gives:

$$\dot{x} = Ax - {BR}^{- 1} {B}^{T} [ Kx ( t ) + f ( t ) + h ( t ) ] + Ed = ( A - {BR}^{- 1} {B}^{T} K ) x ( t ) - {BR}^{- 1} {B}^{T} f ( t ) = {BR}^{- 1} {B}^{T} h ( t ) + Ed \qquad ( 51 )$$

Substituting the equation (51) into the equation (50) gives:
\dot{λ}(t)=\dot{K}x(t)+K[(A−BR⁻¹B^{T}K)x(t)−BR⁻¹B^{T}f(t)=BR⁻¹B^{T}h(t)+Ed]+f(t)+\dot{h}(t) (52)
\dot{λ}(t)=[\dot{K}+K(A−BR⁻¹B^{T}K)]x−KBR⁻¹B^{T}f(t)+\dot{f}(t)−KBR⁻¹ B^{T}h(t)+\dot{h}(t)+KEd (53)

From the equation (32), substituting the equation (45) and combining like terms with the equations (52) and (53) gives:

$$\begin{matrix}\dot{λ} = {C}^{T} Qz - {C}^{T} QCx + {A}^{T} [ Kx ( t ) + f ( t ) + h ( t ) ] & ( 54 ) \\ [ \dot{K} + K ( A - {BR}^{- 1} {B}^{T} K ) ] x - {KBR}^{- 1} {B}^{T} f ( t ) + \dot{f} ( t ) - {KBR}^{- 1} {B}^{T} h ( t ) + \dot{h} ( t ) + KEd = ( {A}^{T} K - {C}^{T} QC ) x + {C}^{T} Qz + {A}^{T} [ f ( t ) + h ( t ) ] & ( 55 )\end{matrix}$$

For x(t):
\dot{K}=−KA−A^{T}K+KBR⁻¹B^{T}K−C^{t}QC (56)

For f(t), where the disturbance is accounted for, gives:
\dot{f}(t)=(BR⁻¹B^{T}−A^{T})f(t)−KEd (57)

For h(t), where the desired set-point is accounted for, gives:
\dot{h}(t)=(BR¹B^{T}−A^{T})(t)+C^{T}Qz (58)

The final conditions K(T), f(T) and h(T) can be solved in a similar manner from the equations (40), (41) and (44).

$$\begin{matrix}λ ( T ) = Kx ( T ) + f ( T ) + h ( T ) & ( 59 ) \\ λ ( T ) = - CFz ( T ) + {C}^{T} FCx ( T ) & ( 60 ) \\ K ( T ) = {C}^{T} FC & ( 61 ) \\ f ( T ) = 0 & ( 62 ) \\ h ( T ) = - {C}^{T} Fz ( T ) & ( 63 )\end{matrix}$$

With this step the derivation of the equations used to solve the optimal control problem are complete. What remains is the non-linear differential equation (56) and the two ordinary first order differential equations (57) and (58). From the equation (56) it is clear that it is in the form of the Differential Riccati equation, independent of f(t) and h(t). However, only the final conditions are known for the equations (56), (57) and (58) meaning that one must integrate backward in time if time-varying matrices are required for K(t), f(t) and h(t). Since the goal of the controller 38 is to have an autonomous non-varying solution, the gain matrices are constant, requiring d(K)/dt=df/dt=dh/dt=0. This results in the Algebraic Riccotti equation given as:
0=−KA−A^{T}K+KBR⁻¹B^{T}K−C^{T}QC (64)
f=−(BR⁻¹B^{T}−A^{T})⁻¹KEd (65)
h=(BR⁻¹B^{T}−A^{T})⁻¹C^{T}Qz (66)

All that remains is to solve for K and substitute into the equations (64)-(66) as:
u=−R⁻¹B^{T}(Kx(t)+f(t)+h(t)) (67)

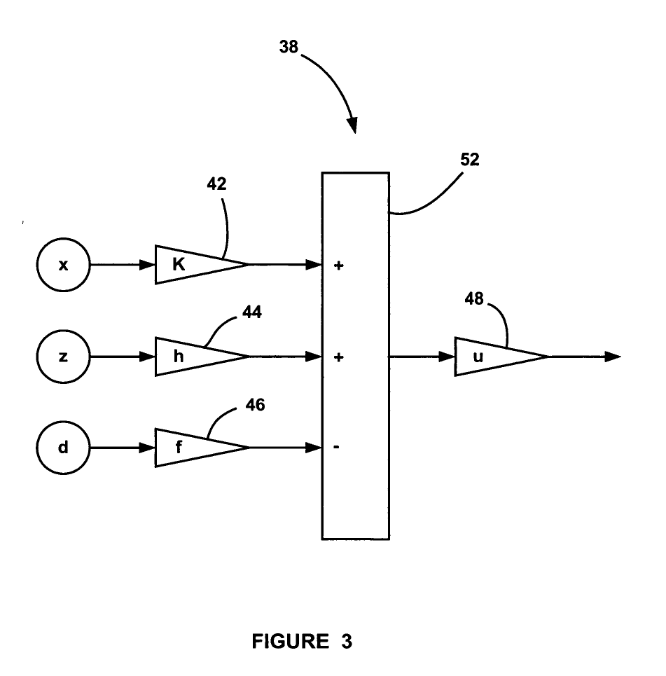

FIG. 3 is a block diagram of the controller 38 showing how the control output u is determined. A multiplier 42 generates the K matrix, a multiplier 44 generates the h matrix and a multiplier 46 generates the f matrix based on the equations discussed above. State variable feedback is applied to the multiplier 42, which generates the K matrix from the equation (64) that is then applied to an adder 52. The desired temperature set-point z of the stack 12 is applied to the multiplier 44. The multiplier 44 generates the h matrix from the equation (66), which is added to the K matrix in the adder 52. The disturbance d or output power of the stack 12 is applied to the multiplier 46 and the f matrix is calculated using the equation (65). The f matrix is subtracted from the K matrix and h matrix in the adder 52. Equation (67) is then solved for the control output from the addition of K(t), f(t) and h(t) which is multiplied by the inverse of R and the transpose of B.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for controlling the temperature of a fuel cell stack in a fuel cell system, said fuel cell system including a coolant loop directing a cooling fluid through the stack, a pump for pumping the cooling fluid through the coolant loop, a radiator for cooling the cooling fluid outside of the stack and a bypass valve for selectively directing the cooling fluid in the coolant loop through the radiator or around the radiator, said method comprising:
determining a first matrix that is representative of the temperature of the cooling fluid coming out of the stack and the temperature of the cooling fluid coming out of the radiator;
determining a second matrix based on a desired temperature set-point of the fuel cell stack;
determining a third matrix based on the output power of the fuel cell stack; and
generating a control matrix for controlling the speed of the pump and the position of the bypass valve by combining the first, second and third matrices.

2. The method according to claim 1 wherein determining the first matrix includes calculating the first matrix based on a state matrix that defines the physical properties of the fuel cell system, an input matrix that defines input effects on the fuel cell system, an output matrix that defines variables being measured, a matrix tuned to a desired response and an R matrix.

3. The method according to claim 2 wherein determining the first matrix includes calculating the first matrix as:
0=−KA−A^{T}K+KBR⁻¹B^{T}K−C^{T}QC,
where K is the first matrix, A is the state matrix that defines the physical properties of the fuel cell system, B is the input matrix that defines input effects on the fuel cell system, C is the output matrix that defines variables being measured and Q is the matrix tuned to a desired response.

4. The method according to claim 1 wherein determining a second matrix includes calculating the second matrix based on a state matrix that defines physical properties of the fuel cell system, an input matrix that defines input effects on the fuel cell system, an output matrix that defines variables being measured and a matrix tuned to a desired response.

5. The method according to claim 4 wherein determining a second matrix includes calculating the second matrix as:
h=(BR⁻¹B^{T}−A^{T})⁻¹C^{T}QZ,
where h is the second matrix, A is the state matrix that defines physical properties of the fuel cell system, B is the input matrix that defines input effects on the fuel cell system, C is the output matrix that defines variables being measured, Q is the matrix tuned to a desired response, and z is the desired temperature set-point of the fuel cell stack.

6. The method according to claim 1 wherein determining a third matrix includes calculating the third matrix using the first matrix, a state matrix that defines physical properties of the fuel cell system, an input matrix that defines input effects on the fuel cell system, an input matrix that defines the effect of stack power and an R matrix.

7. The method according to claim 6 wherein determining a third matrix includes calculating the third matrix as:
f=−(BR⁻¹B^{T}−A^{T})⁻¹KEd,
where f is the third matrix, K is the first matrix, A is the state matrix that defines physical properties of the fuel cell system, B is the input matrix that defines input effects on the fuel cell system, E is the input matrix that defines the effect of stack power and d is the output power of the fuel cell stack.

8. The method according to claim 1 wherein generating a control matrix includes adding the first, second and third matrices and multiplying by the inverse of an R matrix and the transpose of an input matrix that defines input effects on the system as:
u=−R⁻¹B^{T}(Kx(t)+f(t)+h(t)),
where u is the control matrix, K is the first matrix, h is the second matrix, f is the third matrix and B is the input matrix that defines input effects on the system.

9. The method according to claim 1 wherein the pump and the bypass valve are positioned downstream from an output of the radiator in the coolant loop.

10. The method according to claim 9 wherein the bypass valve is positioned farther downstream than the pump.

11. The method according to claim 1 wherein the fuel cell system is on a vehicle.

12. A method for controlling the temperature of a fuel cell stack in a fuel cell system, said method comprising:
developing a model of the fuel cell system that employs non-linear equations; and
controlling the speed of a pump for pumping a cooling fluid through a coolant loop in the fuel cell system and a position of a bypass valve that selectively directs the cooling fluid in the cooling loop through the radiator or around the radiator, wherein controlling the speed of the pump and the position of the bypass valve includes combining the control of the speed of the pump and the position of the bypass valve.

13. The method according to claim 12 wherein controlling the speed of the pump and the position of the bypass valve includes determining a first matrix that is representative of the temperature of the cooling fluid coming out of the stack and the temperature of the cooling fluid coming out of the radiator, determining a second matrix based on a desired temperature set-point of the fuel cell stack, determining a third matrix based on the output power of the fuel cell stack and generating a control matrix for controlling the speed of the pump and the position of the bypass valve by combining the first, second and third matrices.

14. A fuel cell system comprising:
a fuel cell stack;
a radiator;
a coolant loop directing a cooling fluid through the fuel cell stack and the radiator and receiving the cooling fluid from the fuel cell stack and the radiator, said coolant loop including a bypass portion;
a pump for pumping the cooling fluid through the coolant loop, the fuel cell stack and the radiator;
a bypass valve for selectively directing the cooling fluid through the radiator and the bypass portion around the radiator;
an input temperature sensor for measuring the temperature of the cooling fluid entering the fuel cell stack;
an output temperature sensor for measuring the temperature of the cooling fluid exiting the fuel cell stack; and
a controller for controlling the bypass valve and the pump based on the temperature of the cooling fluid, said controller controlling the bypass valve and the pump in combination.

15. The system according to claim 14 wherein the controller determines a first matrix that is representative of the temperature of the cooling fluid coming out of the stack and the temperature of the cooling fluid coming out of the radiator, determines a second matrix based on a desired temperature set-point of the fuel cell stack, determines a third matrix based on the output power of the fuel cell stack, and generates a control matrix for controlling the speed of the pump and the position of the bypass valve by combining the first, second and third matrices.

16. The system according to claim 15 wherein the controller determines the first matrix based on a state matrix that defines the physical properties of the fuel cell system, an input matrix that defines input effects on the fuel cell system, an output matrix that defines variables being measured, a matrix tuned to a desired response and an R matrix.

17. The system according to claim 16 wherein the controller determines the first matrix as:
0=−KA−A^{T}K+KBR⁻¹B^{T}K−C^{T}QC,
where K is the first matrix, A is the state matrix that defines the physical properties of the fuel cell system, B is the input matrix that defines input effects on the fuel cell system, C is the output matrix that defines variables being measured and Q is the matrix tuned to a desired response.

18. The system according to claim 15 wherein the controller determines the second matrix based on a state matrix that defines physical properties of the fuel cell system, an input matrix that defines input effects on the fuel cell system, an output matrix that defines variables being measured and a matrix tuned to a desired response.

19. The system according to claim 18 wherein the controller determines the second matrix as:
h=(BR⁻¹B^{T}−A^{T})⁻¹C^{T}QZ,
where h is the second matrix, A is the state matrix that defines physical properties of the fuel cell system, B is the input matrix that defines input effects on the fuel cell system, C is the output matrix that defines variables being measured, Q is the matrix tuned to a desired response, and z is the desired temperature set-point of the fuel cell stack.

20. The system according to claim 15 wherein the controller determines the third matrix using the first matrix, a state matrix that defines physical properties of the fuel cell system, an input matrix that defines input effects on the fuel cell system, an input matrix that defines the effect of stack power and an R matrix.

21. The system according to claim 20 wherein the controller determines the third matrix as:
f=−(BR⁻¹B^{T}−A^{T})⁻¹KEd,
where f is the third matrix, K is the first matrix, A is the state matrix that defines physical properties of the fuel cell system, B is the input matrix that defines input effects on the fuel cell system, E is the input matrix that defines the effect of stack power and d is the output power of the fuel cell stack.

22. The system according to claim 15 wherein the controller generates the control matrix by adding the first, second and third matrices and multiplying by the inverse of an R matrix and the transpose of an input matrix that defines input effects on the system as:
u=−R⁻¹B^{T}(Kx(t)+f(t)+h(t)),
where u is the control matrix, K is the first matrix, h is the second matrix, f is the third matrix and B is the input matrix that defines input effects on the system.

23. The system according to claim 14 wherein the pump and the bypass valve are positioned downstream from an output of the radiator in the coolant loop.

24. The system according to claim 23 wherein the bypass valve is positioned farther downstream than the pump.

25. The system according to claim 14 wherein the fuel cell system is on a vehicle.
